(19) United States
(12) Patent Application Publication
(10) Pub. No.: US 2022/0288885 A1
(43) Pub. Date: Sep. 15, 2022

(54) Laminated Board and Application Thereof

(71) Applicant: Jinglei JIANG, Yuyao (CN)

(72) Inventor: Jinglei JIANG, Yuyao (CN)

(21) Appl. No.: 17/630,160

(22) PCT Filed: Jul. 27, 2020
(86) PCT No.: PCT/CN2020/104796

§ 371 Date: Jan. 27, 2022

(30) Foreign Application Priority Data
Jul. 25, 2019 (CN) 201910678593.X
Jul. 22, 2020 (CN) 202010711160.2
Jul. 22, 2020 (CN) 202021464472.X

(51) Int. Cl. B32B 3/28; B32B 27/08; B32B 27/32; B32B 37/18

(52) U.S. Cl. CPC B32B 3/28; B32B 27/08; B32B 27/327; B32B 37/182; B32B 2250/03; B32B 2250/242; B32B 2323/043

(57) ABSTRACT

A laminated board and an application thereof. The laminated board comprises a first partial board, a second partial board, a first layer, and a second layer. The first layer is attached to the second layer, and a boundary is formed at the position where the first layer is connected to the second layer. The first partial board comprises one or two selected from the combination of at least part of the first layer and at least part of the layer. The second partial board comprises one or more selected from the combination of other at least part of the first layer and other at least part of the second layer. The first partial board and the second partial board are connected to each other at the edge and are spaced apart from each other to form a cavity. At least part of the second partial board extends to the first partial board to form at least one support structure. The first partial board can be supported in the support structure.

### BACKGROUND OF THE PRESENT INVENTION

### Field of Invention

The present invention relates to the field of panel, and more particularly to a laminated board and application thereof.

### Description of Related Arts

Plastic panels have been widely used in daily life, such as tables, chairs, walls, partitions, toys, and etc., all of which may be fabricated from plastic. A plastic panel has the advantages of light weight, rich color, and various shapes. However, for most plastic panels, there is a large drawback, that is relatively low in strength, making it difficult to withstand a large weight, and once bearing weight for too long, the surface of the plastic panel tends to collapse.

Conventional materials for manufacturing panels are typically wood or metal with sufficient support strength, but too heavy for transportation and installation. Plastic-made panels, even though with lighter weight, are insufficient in strength. Another problem is regarding the surface performance of the panel, wherein a surface of the panel made of wood or metal needs to be subjected to some special treatment to have better scratch resistance, waterproof, and oil-proof properties, but a plastic panel itself has better scratch resistance, water resistance, and oil resistance, relatively to wood and metal.

Accordingly, a way conducted by some of the manufacturers currently is to cover a layer of plastic on the surface of the panel made of wood or metal, which appears to incorporate plastic and conventional materials, thereby improving the drawback of conventional materials, such as easy to be scratched. In fact, the defect of the lower strength of the plastic itself has not actually been overcome, and it does not fully exert the advantage of the light weight of the plastic panel as well. The main part of the entire panel is still a wood or metal material, which is still relatively bulky.

In addition, the requirements of the panel in different application fields are not the same. When applied to a wall, it is possible to have a higher requirement on the support strength of the panel. When applied to a toy, it may require higher impact resistance of the panel, meaning that the plastic covered on the surface of the wood or metallic material may need to change for different application fields. In other words, the performance of conventional panels may meet one of the requirements, but it is difficult to achieve multiple requirements at the same time.

### SUMMARY OF THE PRESENT INVENTION

In order to solve the above technical issues of the prior arts, the present invention provides a laminated board which is good in impact resistance, light in weight, and stable and firm in structure.

Another technical solution provided by the present invention is an ingredient structure which can be made into a double-layer blow-molded laminated board, which is good in impact resistance, firm and stable in structure, and light in weight.

Another technical solution provided is an ingredient structure that can be made into a three-layer laminated board that is good in impact resistance and firm and stable in structure.

Another technical solution adopted by the present invention is to provide a blow-molded laminated board, which comprises an upper panel member and a lower panel member, wherein the layer and the lower panel member are formed by blow-molding to form a hollow structure between the upper panel member and the lower panel member, and is characterized in that each of the upper panel member and the lower panel member respectively comprises an outer layer and an inner layer, wherein the lower panel member has a predetermined number of portions being recessed in a direction toward the upper panel member until the inner layer of the lower panel member and the inner layer of the upper panel member are fused and joined with each other so as to form a predetermined number of bonding support structures respectively.

Preferably, each of the upper panel member and the lower panel member comprises an outer layer, an intermediate layer, and an inner layer, wherein the lower panel member has a predetermined number of portion being recessed in the direction toward the upper panel member until the inner layer of the lower panel member and the inner layer of the upper panel member are fused and joined with each other so as to form a predetermined number of bonding support structures distributed in a predetermined manner.

In order to improve the strength of the edge structure of the laminated board, the upper panel member has an outer bending wall bent downwards from an outer edge thereof, and the lower panel member has an inner bending wall bent downwards from an outer edge thereof, wherein a bottom of the inner layer of the outer bending wall and a bottom of the inner layer of the inner bending wall are fused and integrated with each other.

In order to improve the structural strength of the laminated board, the bonding support structure may be in a point-like structure or a strip-like structure.

Preferably, at least a reinforcing rib is provided at the bonding support structure.

Further preferably, the bonding support structure includes two reinforcing ribs arranged at the bonding support structure, and correspondingly, three contact peak points which are arranged at interval alternately with the two reinforcing ribs in a spacing manner.

According to another technical solution adopted by the present invention, the raw material structures of each layer of the double-layer blow-molded laminated board are that the outer layer of each of the upper panel member and the lower panel member is made of high density polyethylene, and the inner layer of each of the upper panel member and the lower panel member is selected from a mixture of high density polyethylene, metallocene polyethylene and calcium carbonate or a mixture of high density polyethylene, metallocene polyethylene and glass fibers.

Preferably, for the inner layer, the mass percentage of the metallocene polyethylene is 10-15%, the mass percentage of the calcium carbonate is 15-20%, and the rest is high density polyethylene. Alternatively, for the inner layer, the mass percentage of the metallocene polyethylene is 10-15%, the mass percentage of the glass fiber is 15-25%, and the rest is high density polyethylene.

According to another technical solution adopted by the present invention and based on the ingredient of the laminated board of the triple-layer blow-molded hollow composite panel, the outer layer of each of the upper panel member and the lower panel member is made of high density polyethylene, the intermediate layer of each of the upper panel member and the lower panel member is made of a mixture of high density polyethylene and calcium carbonate or a mixture of high density polyethylene and glass fibers, and the inner layer of each of the upper panel member and the lower panel member is made of metallocene polyethylene.

According to a preferred embodiment, for the intermediate layer, the mass percentage of the high density polyethylene is 70-85%, and the mass percentage of calcium carbonate is 15-30%.

According to another preferred embodiment, for the intermediate layer, the mass percentage of the high density polyethylene is 60-85%, and the mass percentage of glass fiber is 15-40%.

Compared with the conventional art, the advantage of the present invention includes that the multi-layer blow-molded laminated board only utilizes the blow-molded hollow structures of the upper and lower panel members to construct a lightweight, rigid and strong impact-resistant panel structure, wherein a predetermined number of portions of the lower panel member is recessed in the direction toward the upper panel member till the inner layer of the lower panel member and the inner layer of the upper panel member are fused and joined with each other so as to form a predetermined number of bonding support structures distributed in a predetermined manner to improve the structural strength of the flow-molded panel. The outer layer can be made of a material with high surface strength, scratch resistance and oil stain resistance. The inner layer can be made of a material with a low heat-plastic shrinkage ratio to provide a frame support effect. When the intermediate layer is made of a material with high toughness, certain elasticity, and energy absorption, the intermediate layer is able to provide a buffering effect to effectively alleviate the damage to the panel due to impact and drop, thereby further improving the overall structural strength of the blow-molded panel.

An advantage of the present invention is to provide a laminated board and application thereof, wherein the laminated board is mainly made of plastics and has the advantage of the lightweight of plastics while also has a better strength.

Another advantage of the present invention is to provide a laminated board and application thereof, wherein the laminated board is able to be applied to different fields and to achieve different requirements of different fields. In other words, the laminated board can achieve multiple requirements at the same time.

Another advantage of the present invention is to provide a laminated board and application thereof, wherein the laminated board has better scratch resistance, impact resistance and support strength, while the manufacturing material of the laminated board itself does not require a better scratch resistance, impact resistance, and support strength at the same time.

Another advantage of the present invention is to provide a laminate panel and application thereof, wherein the laminate panel includes a first panel member and a second panel member arranged opposingly and spacingly with the first panel member, wherein at least one portion of the second panel member extends to form at least one support portion, wherein the first panel member is supported on the support portion, thereby enhancing the structural strength of the laminate panel.

Another advantage of the present invention is to provide a laminated board and application thereof, in which the first and second panel members form a hollow structure, thereby having a higher structural strength with lighter mass.

Another advantage of the present invention is to provide a laminated board and application thereof, wherein the first panel member of the laminated board is able be arranged to have two or more layers, and at least two layers of the first panel member can achieve different performances respectively, so as to grant the first panel member a greater performance.

Another advantage of the present invention is to provide a laminated board and application thereof, wherein the second panel member of the laminated board may be arranged to have two or more layers, and at least two sides of the second panel member may achieve different performances respectively, so as to grant the second panel member a greater performance.

Another advantage of the present invention is to provide a laminate panel and application thereof, wherein the support portion may be a structure having two or more layers, so as to ensure the support portion having a better performance.

Another advantage of the present invention is to provide a laminated board and application thereof, wherein the laminated board includes at least two or more layers, while the performance of at least one of the layers is different from the performance of another layer, so that the entire laminated board can possess a greater performance.

Another advantage of the present invention is to provide a laminated board and application thereof, wherein each layer of the laminated board may be made in a variety of ways, such as coating, laminating, and etc., which is simple to manufacture.

According to an aspect of the present invention, the present invention provides a laminated board, including:

a first panel member;

a second panel member;

a first layer; and

a second layer, wherein the first layer is attached with the second layer such that the connection between the first layer and the second layer forms a boundary, wherein the first panel member is selected from the group consisting of at least a portion of the first layer, at least a portion of the second layer, and combination thereof, wherein the second panel member is selected from the group consisting of at least another portion of the first layer, at least another portion of the second layer, and combination thereof, wherein the first panel member and the second panel member are connected at edges and maintain a space therebetween to define a cavity maintained between the first and second layers, wherein at least one portion of the second panel member extends toward the first panel member to form at least one support structure, wherein the first panel member is capable of being supported by the support structure.

According to one embodiment of the present invention, the first layer is attached to the second layer by the means selected from the group consisting of bonding connection and pressing connection.

According to one embodiment of the present invention, the first layer is formed on a surface of the second layer by the means selected from the group consisting of coating, compression, molding, and injection molding.

According to one embodiment of the present invention, the laminated board further includes a third layer, wherein the third layer is positioned between the first layer and the third layer, wherein the third layer is attached on the second layer and the connection between the second layer and the third layer to form a boundary therebetween, wherein the first panel member is selected from the group consisting of at least a portion of the first layer, at least a portion of the second layer, at least a portion of the third layer, and combinations thereof, wherein the second panel member is selected from the group consisting of at least another portion of the first layer, at least another portion of the second layer, at least another portion of the third layer, and combinations thereof.

According to one embodiment of the present invention, the material of the first layer comprises high density polyethylene, wherein the material of the third layer is selected from the group consisting of high density polyethylene plus calcium carbonate, high density polyethylene plus glass fiber, and combination thereof, wherein the material of the second layer is selected from the group consisting of metallocene polyethylene plus calcium carbonate, metallocene polyethylene plus glass fiber, and combination thereof.

According to one embodiment of the present invention, at least a portion of the second panel member is recessed towards the cavity to form the support structure such that at least one recess is formed on the surface of the second panel member.

According to one embodiment of the present invention, the support structure forms at least one contact peak point and the first panel member is supported at the position of the contact peak point.

According to one embodiment of the present invention, the second panel member includes a second panel member body and the at least one support structure, wherein the at least one support structure includes a support sidewall and a support topwall, wherein the support sidewall is integrally extended from the second panel member body toward the first panel member and positioned between the support topwall and the second panel member body, wherein the first panel member is supported on the support topwall.

According to one embodiment of the present invention, the second panel member includes a second panel member body and the at least one support structure, wherein the at least one support structure includes a support sidewall and a support topwall, wherein the support sidewall is integrally extended from the second panel member body toward the first panel member and positioned between the support topwall and the second panel member body, wherein the support topwall undulates to form a plurality of contact peak points.

According to an embodiment of the present invention, the laminated board further includes a reinforcing rib, wherein the reinforcing rib is arranged in the recess, and the support topwall of the support structure protrudes towards the first panel member to form the reinforcing rib.

According to another aspect of the present invention, the present invention provides a desktop panel, adapted for being supported on at least a leg assembly so as to form a table, wherein the desktop panel includes:

a first panel member;

a second panel member;

a first layer; and

a second layer, wherein the first layer is attached to the second layer such that the connection between the first layer and the second layer forms a boundary, wherein the first panel member is selected from the group consisting of at least a portion of the first layer, at least a portion of the second layer, and combination thereof, wherein the second panel member is selected from the group consisting of at least another portion of the first layer, at least another portion of the second layer, and combination thereof, wherein the first panel member and the second panel member are connected at edges and maintain a space therebetween to define a cavity maintained between the first and second layers, wherein at least one portion of the second panel member extends toward the first panel member to form at least one support structure, wherein the first panel member is capable of being supported by the support structure, wherein the second panel member is conFIGured to be supported by the leg assembly so as to form the table.

According to another aspect of the present invention, the present invention provides a table, including:

at least a leg assembly; and

a desktop panel, wherein the desktop panel is adapted to be supported on the leg assembly, wherein the desktop panel comprises:

a first panel member;

a second panel member;

a first layer; and

a second layer, wherein the first layer is attached to the second layer such that the connection between the first layer and the second layer forms a boundary, wherein the first panel member is selected from the group consisting of at least a portion of the first layer, at least a portion of the second layer, and combination thereof, wherein the second panel member is selected from the group consisting of at least another portion of the first layer, at least another portion of the second layer, and combination thereof, wherein the first panel member and the second panel member are connected at edges and maintain a space therebetween to define a cavity maintained between the first and second layers, wherein at least one portion of the second panel member extends toward the first panel member to form at least one support structure, wherein the first panel member is capable of being supported on the support structure.

### BRIEF DESCRIPTION OF THE DRAWINGS

FIG. 1 is a structural perspective view of a first preferred embodiment of the present invention.

FIG. 2 is an enlarged perspective view of the encircled portion A of FIG. 1.

FIG. 3 is an enlarged perspective view of the encircled portion B of FIG. 2.

FIG. 4 is a structural perspective view of a second preferred embodiment of the present invention.

FIG. 5A is a perspective view illustrating a laminated board according to the above preferred embodiment of the present invention.

FIG. 5B is a perspective view of another viewing angle illustrating the laminated board according to the above preferred embodiment of the present invention.

FIG. 6A is an enlarged perspective view, illustrating the encircled portion J of FIG. 5B, of the laminated board according to the above preferred embodiment of the present invention.

FIG. 6B is an enlarged perspective view of another viewing angle, illustrating the encircled portion J of FIG. 5B, of the laminated board according to the above preferred embodiment of the present invention.

FIG. 6C is an enlarged sectional view, illustrating the encircled portion J of FIG. 5B, of the laminated board according to the above preferred embodiment of the present invention.

FIG. 7 is a schematic view illustrating a manufacture process of the laminated board according to the above preferred embodiment of the present invention.

FIG. 8 is a schematic view illustrating another manufacture process of the laminated board according to the above preferred embodiment of the present invention.

FIG. 9 is a schematic view illustrating another manufacture process of the laminated board according to the above preferred embodiment of the present invention.

FIG. 10 is a schematic view illustrating another manufacture process of the laminated board according to the above preferred embodiment of the present invention.

FIG. 11A is a sectional perspective view of a laminated board according to another preferred embodiment of the present invention.

FIG. 11B is a sectional view, illustrating the encircled portion K of FIG. 11A, according to the above another preferred embodiment of the present invention.

FIG. 11C is a perspective view, illustrating the encircled portion K of FIG. 11A, according to another alternative mode of the above another preferred embodiment of the present invention.

FIG. 11D is a perspective view, illustrating the encircled portion K of FIG. 11A, according to another alternative mode of the above another preferred embodiment of the present invention.

FIG. 11E is a perspective view, illustrating the encircled portion K of FIG. 11A, according to another alternative mode of the above another preferred embodiment of the present invention.

FIG. 12 is a schematic view illustrating an application of the laminated board according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Those skilled in the art should understand that, in the disclosure of the present invention, terminologies of “longitudinal,” “lateral,” “upper,” “front,” “back,” “left,” “right,” “perpendicular,” “horizontal,” “top,” “bottom,” “inner,” “outer,” and etc. just indicate relations of direction or position are based on the relations of direction or position shown in the appended drawings, which is only to facilitate descriptions of the present invention and to simplify the descriptions, rather than to indicate or imply that the referred device or element must apply specific direction or to be operated or conFIGured in specific direction. Therefore, the above-mentioned terminologies shall not be interpreted as confine to the present invention.

It is understandable that the term “a” should be understood as “at least one” or “one or more”. In other words, in one embodiment, the number of an element can be one and in other embodiment the number of the element can be greater than one. The term “a” is not construed as a limitation of quantity.

The present invention is described in further detail below referring to the accompanying drawings.

### Embodiment 1

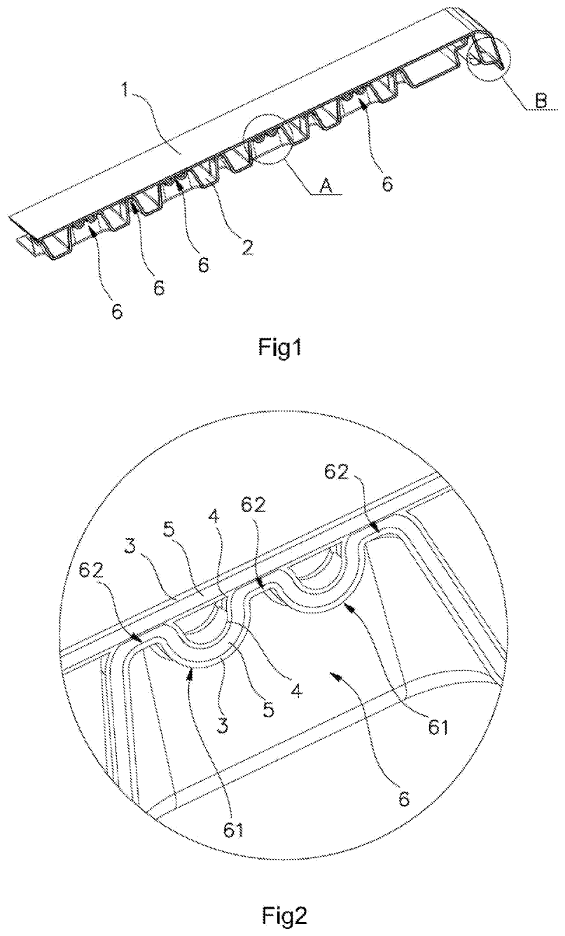

As shown in FIGS. 1-3, according to a first preferred embodiment of the present invention, the multi-layer laminated board according to the present embodiment comprises an upper panel member 1 and a lower panel member 2, wherein the upper panel member 1 and the lower panel member 2 form a hollow structure through a blow molding process.

Each of the upper panel member 1 and the lower panel member 2 of the present embodiment is a three-layer structure. That is each of the upper and lower panel members 1, 2 comprises an outer layer 3, an intermediate layer 5 and an inner layer 4, wherein the lower panel member 2 is recessed upwards, i.e., in the direction toward the upper panel member 1, until the inner layer 4 of the lower panel member and the inner layer 4 of the upper panel member 1 are fused and joined with each other to form a predetermined number of bonding support structures 6 distributed in a predetermined manner.

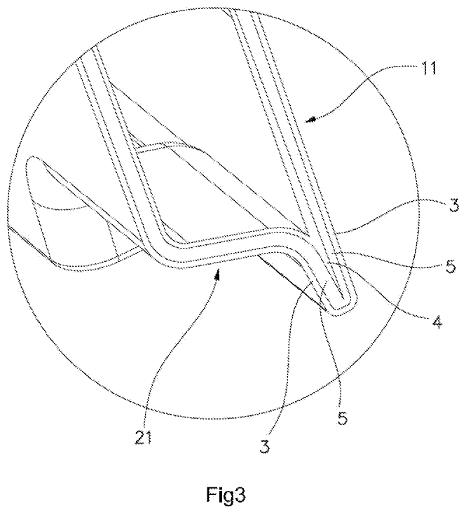

The edge structure of the blow-molded laminated board is as follows. As shown in FIG. 3, a surrounding outer edge of the upper panel member 1 bends downwards to form an outer bending wall 11 and a surrounding outer edge of the lower panel member 2 slightly bends downwards to form an inner bending wall 21 to connect with the outer being wall 11 of the upper panel member 1 such that the inner layer 4 of a bottom of the outer bending wall 11 and the inner layer 4 of a bottom of the inner bending wall 21 are integrally fused and joined with each other to form an integrated body.

According to the present embodiment, the bonding support structure 6, having a strip-shape, has two reinforcing ribs 61 arranged therein. As shown in FIGS. 1 and 2, the bonding support structure 61 has three contact peak points 62 spacedly formed therein and arranged alternately at intervals with the reinforcing ribs 61.

The raw material structure of the double-outer single-inner three-layer blow-molded laminated board is as follows: each of the outer layers 3 of the upper panel member 1 and the lower panel member 2 is made of high density polyethylene, each of the intermediate layers 5 of the upper panel member 1 and the lower panel member 2 is made of a mixture of high density polyethylene and calcium carbonate or a mixture of high density polyethylene and glass fibers, and each of the inner layers 4 of the upper panel member 1 and the lower panel member 2 is made of metallocene polyethylene.

Accordingly, the outer layer 3 has the advantages of high surface strength, scratch resistance, and strong oil stain resistance, while the inner layer 4 is low in thermoplastic shrinkage ratio to provide the frame structure support, wherein the intermediate layer 5 has certain elasticity and energy absorption property and high toughness, which is capable of effectively relieving the damage to the laminated board caused by impact and drop.

According to the above first preferred embodiment of the present invention, if the intermediate layer 5 employs high density polyethylene and calcium carbonate, the mass percentage of the high density polyethylene is 70-85%, and the mass percentage of the calcium carbonate is 15-30%.

According to the above first preferred embodiment of the present invention, if the intermediate layer 5 employs high density polyethylene and glass fiber, the mass percentage of the high density polyethylene is 60-85%, and the mass percentage of the glass fiber is 15-40%.

Each of the upper panel member 1 and the lower layer 2 of the multi-layer blow-molded laminated board of the present embodiment adopts the double-outer single-inner three-layer structure. When the outer layer 3 is subjected to a strong impact and falling, the inner layer 4 may even be actively broken to absorb the energy that the inner layer 4 may still be restored due to the elastic pull-back force of the material of the intermediate layer 5, so as to ensure a completeness of the entire panel as well as its application functions. Thus, the laminated board has the advantages of high surface strength, high flatness, overall impact resistance, deformation resistance, more stable structure, higher performance, longer service life, and etc.

The multi-layer blow-molded laminated board can be applied to a plurality of different applications, such as being applied in table and chair, being utilized as a desk panel, a seat panel of a chair, a back panel, and etc. It may also applied to products with panels that are easily broken or applied to construction materials such as wall panel, wallboard, door panel, fence board, outdoor floor, thermal insulation panel, compartment panel, and etc.

According to the above first preferred embodiment of the present invention, for the outer layer 3, the parameters of the high density polyethylene used are as follows: melt: 1.5 g/10 min, bending strength: 900 MPa, Shore D69.

According to the above first preferred embodiment of the present invention, for the intermediate layer 5, the parameters of the high density polyethylene used are as follows: melt: 0.35 g/10 min, bending strength: 1050 MPa, Shore D63.

According to a first preferred embodiment of the present invention, the parameters of the metallocene polyethylene employed in the inner layer 4 are as follows:

Melt: 2.0 g/10 min;

Elongation at Break: Longitudinal 420%, Transverse 830%;

Tensile Strength at Break: Longitudinal 62 MPa, Transverse 25 MPa;

Dart Impact Strength <48 g;

Escroman Dorf Tear Strength: Longitudinal 21° C., transverse 430° C.

In addition, those skilled in the art would appreciate that, as a simplified application, the outer layer, the intermediate layer and the inner layer may be composed of the same material, or different brands and grades of the same material, such as the uniform used of high density polyethylene. Also, the outer layer facing outside can be made of a grade of material with a higher hardness and a bright color, and the intermediate layer can be a layer of mixed material, and the inner layer can be filled with recycled material with a certain proportion of structural filling material, that results in cost savings and rapid change of color.

### Embodiment 2

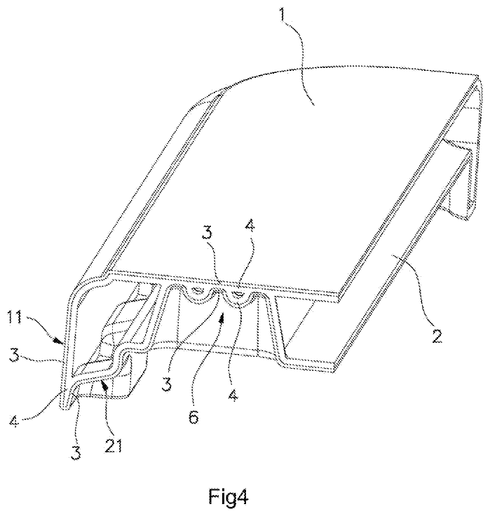

As shown in FIG. 4, according to a second preferred embodiment of the present invention, each of the upper panel member 1 and the lower layer 2 of the present embodiment is a double-layer structure, which comprises an outer layer 3 and an inner layer 4. Besides, the lower panel member 2 is recessed in the direction toward the upper panel member 1 till the inner layer of the lower panel member and the inner layer of the upper panel member 1 are fused and joined with each other so as to form a predetermined number of bonding support structures 6 distributed in a predetermined manner.

The material structure of the double-layer blow-molded laminated board is as follows: each of the outer layers 3 of the upper panel member 1 and the lower panel member 2 is made of high density polyethylene, and each of the inner layers 4 of the upper panel member 1 and the lower panel member 2 is made of a mixture of high density polyethylene, metallocene polyethylene, and calcium carbonate or a mixture of high density polyethylene, metallocene polyethylene, and glass fiber.

According to the above second preferred embodiment of the present invention, for the inner layer 4, the mass percentage of the metallocene polyethylene is 10-15%, the mass percentage of calcium carbonate is 15-20%, and the rest is high density polyethylene; or that the mass percentage of the metallocene polyethylene of the inner layer is 10-15%, the mass percentage of the glass fiber is 15-25%, and the rest is high density polyethylene.

In addition, the parameter performance of the high density polyethylene and the metallocene polyethylene employed in the present embodiment may be referred to the Embodiment 1, which will not be repeated herein.

The foregoing is merely preferred embodiment of the present invention. It should be noted that various modifications or improvements can be made to the present invention without departing from the principles of the present invention, such as the outer layer, the intermediate layer and the inner layer of the upper panel member, and the outer layer, the intermediate layer and the inner layer of the lower panel member, all of which shall be considered to be within the scope of the present invention.

Referring to FIGS. 5A and 7, a laminated board 1′ and manufacturing process thereof according to another preferred embodiment of the present invention are illustrated.

The laminated board 1′ includes a first panel member 10′ and a second panel member 20′, wherein a predetermined spacing is able to be maintained between the first panel member 10′ and the second panel member 20′ so as to form a cavity 100′ therebetween while edge positions thereof are connected with each other so as to form a hollow structure.

The first panel member 10′ may be a single-layer, double-layer, or multi-layer structure, and the second panel member 20′ may be a single-layer, double-layer, triple-layer, or multi-layer structure. Preferably, at least one layer of the first panel member 10′ extends integrally to at least one layer of the second panel member 20′ so as to reinforce the connection strength at the connection area of the first panel member 10′ and the second panel member 20′.

When the first panel member 10′ or the second panel member 20′ is a double layer or multi-layer structure, the performance requirements of each layer of the first panel member 10′ or the second panel member 20′ may not be the same, and each layer may possess its own advantageous performance, thereby achieving excellent performance as a whole.

In particular, the first panel member 10′ includes a first layer of first panel member 11′ and a second layer of first panel member 12′, wherein the first layer of first panel member 11′ is laminated with the second layer of first panel member 12′. A boundary would be formed at the connection between the first layer of first panel member 11′ and the second layer of first panel member 12′. The second panel member 20′ may include a first layer of second panel member 21′ and a second layer of second panel member 22′, wherein the first layer of second panel member 21′ is laminated with the second layer of second panel member 22′, and a boundary would be formed at the connection between the first layer of second panel member 21′ and the second layer of second panel member 22′.

The first layer of first panel member 11′ of the first panel member 10′ may have a better scratch resistance, while the second layer of first panel member 12′ of the first panel member 10′ may have a better supporting strength. The first layer of first panel member 11′ may be located on an outer side of the second layer of second panel member 22′ such that the first panel member 10′ of the laminate panel 1′ may have both good scratch resistance and better supporting strength. In other words, the first panel member 10′ of the laminated board 1′ may be applied in situations where scratch resistance requirement is high and also be applied in situations where the supporting strength requirement is high.

The first layer of second panel member 21′ of the second panel member 20′ may have a better elasticity, while the second layer of second panel member 22′ of the second panel member 20′ may have a better supporting strength. The first layer of second panel member 21′ may be located on the outer side of the second layer of second panel member 22′, such that the second panel member 20′ of the laminate panel 1′ may have both relatively good elasticity and good supporting strength.

The layers of the first panel member 10′ and the layers of the second panel member 20′ may be the same or different.

Further, according to this embodiment, the laminated board 1′ includes a first layer 30′ and a second layer 40′, wherein the first layer 30′ is laminated with the second layer 40′, wherein the first panel member 10′ may be selected from the group consisting of at least a portion of the first layer 30′, at least a portion of the second layer 40′, and combination thereof, wherein the second panel member 20′ may be selected from the group consisting of at least another portion of the first layer 30′, at least another portion of the second layer 40′, and combination thereof.

In other words, the first layer of the first layer of first panel member 11′ of the first panel member 10′ may be at least partially the first layer 30′, and the second layer of the second layer of first panel member 12′ of the first panel member 10′ may be at least a portion of the second layer 40′. The first layer of first layer of second panel member 21′ of the second panel member 20′ may be other at least another portion of the first layer 30′, and the second layer of second layer of second panel member 22′ of the second panel member 20′ may be at least another portion of the second layer 40′.

Further, according to the present embodiment, the first layer 30′ is completely laminated with the second layer 40′, and the first layer 30′ and the second layer 40′ are stacked and respectively extend surroundingly around so as to form a hollow structure. It will be appreciated that the first panel member 10′ may be a double-layer, triple-layer or multi-layer structure, or may be a single layer structure. For example, the first panel member 10′ may include a portion of the first layer 30′, and the second panel member 20′ may include the other portion of the first layer 30′ and the entire second layer 40′. That is, the second layer 40′ covers at least a portion of the first layer 30′. Alternatively, the second panel member 20′ may be a double-layer, triple-layer, or multi-layer structure, or may be a single layer structure. For example, the first panel member 10′ may include a portion of the second layer 40′ and the entire first layer 30′, and the second panel member 20′ may include the other portion of the second layer 40′. That is, the first layer 30′ covers at least a portion of the second layer 40′.

Further, the laminated board 1′ includes a third layer 50′, wherein the second layer 40′ is positioned between the first layer 30′ and the third layer 50′, wherein the first panel member 10′ is selected from the group consisting of at least a portion of the first layer 30′, at least a portion of the second layer 40′, at least a portion of the third layer 50′, and combinations thereof, wherein the second panel member 20′ is selected from the group consisting of at least another portion of the first layer 30′, at least another portion of the second layer 40′, at least another portion of the third layer 50′, and combinations thereof.

According to this embodiment, the first panel member 10′ includes the first layer 30′ portion, the second layer 40′ portion, and the third layer 50′ portion, wherein the second panel member 20′ includes the other first layer 30′ portion, the other second layer 40′ portion, and the other third layer 50′ portion. That is, the first panel member 10′ further includes a third layer of first panel member 13′, the second panel member 20′ further includes a third layer of second panel member 23′, and the third layer of first panel member 13′ is integrally extended to the third layer of second panel member 23′. The third layer 50′ of the laminated board 1′ includes the third layer of first panel member 13′ and the third layer of second panel member 23′.

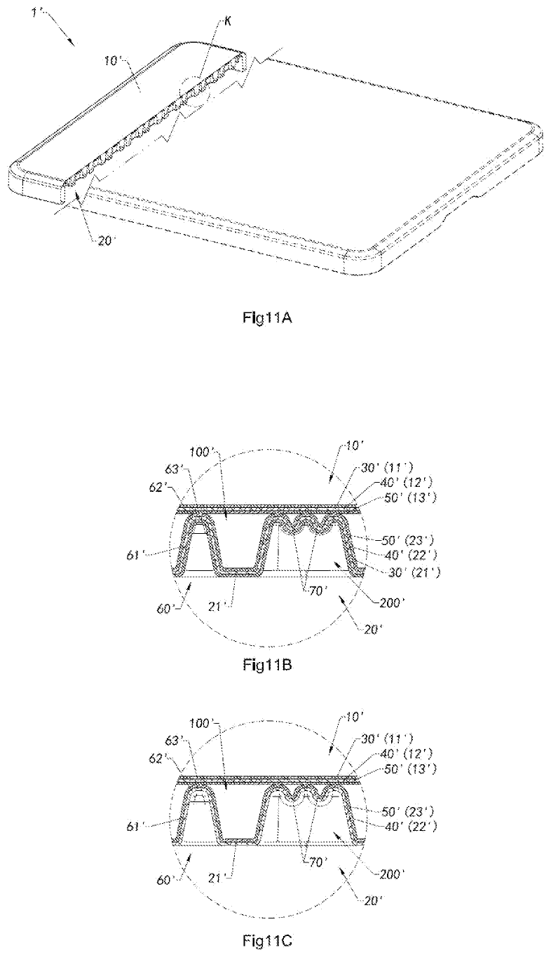

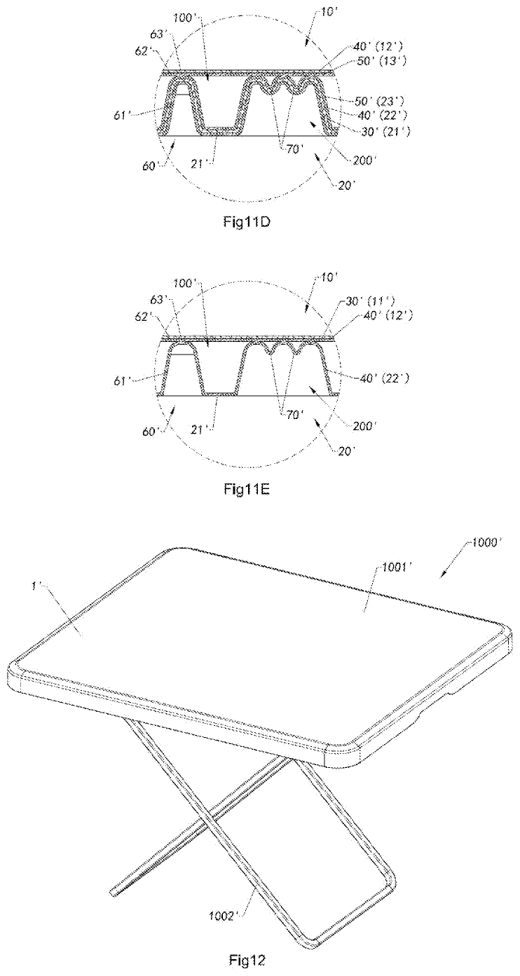

It will be appreciated that, the first panel member 10′ may be a single-layer, double-layer, triple-layer, or multi-layer structure, and the second panel member 20′ may be a single-layer, double-layer, triple layer, or multi-layer structure, for example, as illustrated in FIGS. 11C-11 E. For the laminate panel 1′, as illustrated in FIGS. 11C, the first panel member 10′ may include at least a portion of the first layer 30′, at least a portion of the second layer 40′, and at least a portion of the third layer 50′, wherein the second panel member 20′ may include at least a portion of the second layer 40′ and at least a portion of the third layer 50′. For the laminated board 1′, as illustrated in FIG. 11D, the first panel member 10′ may include at least a portion of the second layer 40′ and at least a portion of the third layer 50′, wherein the second panel member 20′ may include at least a portion of the first layer 30′, at least a portion of the second layer 40′, and at least a portion of the third layer 50′. For the laminated board 1′, as illustrated in FIG. 11E, the first panel member 10′ may include at least a portion of the second layer 30′ and at least a portion of the third layer 40′, wherein the second panel member 20′ may include at least a portion of the third layer 40′.

Further, according to the present embodiment, for the laminated board 1′, the first layer of first panel member 11′ of the first panel member 10′ and the first layer of second panel member 21′ of the second panel member 20′ are located in the same layer and extended integrally. The second layer of first panel member 12′ of the first panel member 10′ and the second layer of second panel member 22′ of the second panel member 20′ are located in the same layer and extended integrally. The third layer of first panel member 13′ of the first panel member 10′ and the third layer of second panel member 23′ of the second panel member 20′ are located in the same layer and extended integrally.

The layers of the laminated board 1′ are designed to have different properties respectively. For example, the first layer 30′ is designed to be scratch resistant, and its scratch resistance performance is superior to the second layer 40′ and the third layer 50′. For example, the second layer 40′ is designed to withstand impact and its impact resistance performance is superior to the first layer 30′ and the third layer 50′. For example, the third layer 50′ is designed to have better supporting strength which is superior to the first layer 30′ and the second layer 40′.

Optionally, the first layer 30′ may be made of high density polyethylene, the second layer 40′ may be made of high density polyethylene plus calcium carbonate or a high density polyethylene plus glass fiber, and the third layer 50′ may be made of metallocene polyethylene.

When the first layer 10′ of the fusion panel 1′ is made of high density polyethylene, the relative parameters of the high density polyethylene include: melt: 1.5 g/10 min, bending strength: 900 MPa, Shore D69.

When the second layer 20′ of the laminated board 1′ is made of high density polyethylene plus calcium carbonate, the mass percentage of calcium carbonate may be 15-30%, the mass percentage of the high density polyethylene is 70-85%, and the parameters related to the high density polyethylene may be: melt: 0.35 g/10 min, bending strength: 1050 MPa, Shore D63.

When the second layer 20′ of the fusion panel 1′ is made of high density polyethylene plus glass fiber, the mass percentage of the glass fiber can be 15-40%, the mass percentage of the high density polyethylene is 60-85%, and the parameters related to the high density polyethylene can be: melt: 0.35 g/10 min, bending strength: 1050 MPa, Shore D63.

When the third layer 50′ of the laminated board 1′ is made of metallocene polyethylene, the relevant parameters of the metallocene polyethylene may be: melt: 2.0 g/10 min, Elongation at Break: longitudinal 420%, transverse 830%, Tensile Strength at Break: longitudinal 62 MPa, transverse 25 MPa, Dart Impact Strength <48 g, Escroman Dorf Tear Strength: longitudinal 21° C., transverse 430° C.

Further, at least a portion of the second panel member 20′ of the laminated board 1′ is protruded toward an inner wall of the first panel member 10′ to form at least one support structure 60′, wherein the support structure 60′ is utilized to support the first panel member 10′. It is appreciated that the support structure 60′ may be directly in contact with the first panel member 10′, so as for supporting the first panel member 10′. Alternatively, a medium is provided between the support structure 60′ and the first panel member 10′, and the support structure 60′ is indirectly supporting the first panel member 10′. Alternatively, a space is formed between the support structure 60′ and the first panel member 10′, and the first panel member 10′ may be moved for a distance toward the support structure 60′ so as to be supported on the support structure 60′. In this embodiment, the support structure 60′ just supports against the first panel member 10′.

The support structure 60′ may be formed through protruding the third layer 50′ portion of the second panel member 20′ toward the inside of the cavity 100′ or through protruding both the second layer 40′ portion and the third layer 50′ portion of the second panel member 20′ toward the inside of the cavity or through protruding all the first layer 30′ portion, the second layer 40′ portion and the third layer 50′ portion of the second panel member 20′ toward the inside of the cavity 100′. According to the present embodiment, the support structure 60′ is implemented to be formed through protruding all the first layer 30′ portion, the second layer 40′ portion and the third layer 50′ portion of the second panel member 20′ toward the interior of the cavity 100′. In other words, at least a portion of the second panel member 20′ is recessed to form at least one recessed cavity 200′ on a lower surface thereof, wherein the recessed cavity 200′ is corresponding to the support structure 60′.

In other words, at least a portion of the second panel member 20′ protrudes toward one side of the second panel member 20′ to form the support structure 60′ and the recessed cavity 200′ is formed on the other side of the second panel member 20′.

A sectional view of the recessed cavity 200′ has a reverse W-shape, while an overall shape of the whole recessed cavity 200′ may be in an oblong shape with two curved arc ends forming rims extending upwardly and inwardly so as to form the support structure 60′ being capable of reinforcing the second panel member 20′.

The second panel member 20′ may include a second panel member body 21′ and at least one of the support structures 60′, wherein each of the support structures 60′ is integrally extended from the second panel member body 21′ while the second panel member body 21′ and the first panel member 10′ remain spaced apart. Each of the support structures 60′ includes a support sidewall 61′ and a support topwall 62′, wherein the support sidewall 61′ is extended between the second panel member body 21′ and the support topwall 62′, and the first panel member 10′ is adapted to be supported on the support topwall 62′.

The support topwall 62′ is configured in a slanted manner such that the included angle between the support topwall 62′ and the second panel member body 21′ is an obtuse angle. The support structure 60′ gradually reduces its size from the second panel member body 21′ toward the first panel member 10′ to form a structure having a bigger bottom portion and smaller top portion to securely support the first panel member 10′ on the second panel member body 21′ of the second panel member 20′.

According to the present embodiment, the support structure 60′ may be formed through stretching at least a portion of the second panel member 20′, such that a thickness of the support structure 60′ is less than a thickness of the first panel member 10′. In particular, in the initial state, the thickness of the first panel member 10′ and the second panel member 20′ may be the same, and then during the blow molding formation of the support structure 60′, the second panel member 20′ is stretched, such that the thickness of the support structure 60′ of the second panel member 20′ is less than the thickness of the first panel member 10′. In view of heat dissipation, since the thickness of the support structure 60′ is relatively thinner that faciliates heat dissipation.

Further, the support structure 60′ of the second panel member 20′ has at least one reinforcement rib 70′ formed and extended between the support sidewalls 61′ thereof to provide supporting effect. According to the present embodiment, at least a portion of the support structure 60′ protrudes outward to form the at least one reinforcing rib 70′. The reinforcing ribs 70′ may be multiple in quantity and arranged in a spaced manner.

The supporting structure 60′ and the reinforcing rib 70′ are formed on the second panel member 20′ that enhances the structural strength of the laminated board 1′ without increasing an overall weight of the laminated board 1′ and, besides, the requirement for manufacturing materials is also lowered to obtain the laminated board with excellent performance. Further, since the second panel member 20′ is stretched to form the support structure 60′ and the reinforcing rib 70′, the thickness of various positions of the second panel member 20′ can be reduced, thereby facilitating heat dissipation uniformity in the manufacturing process.

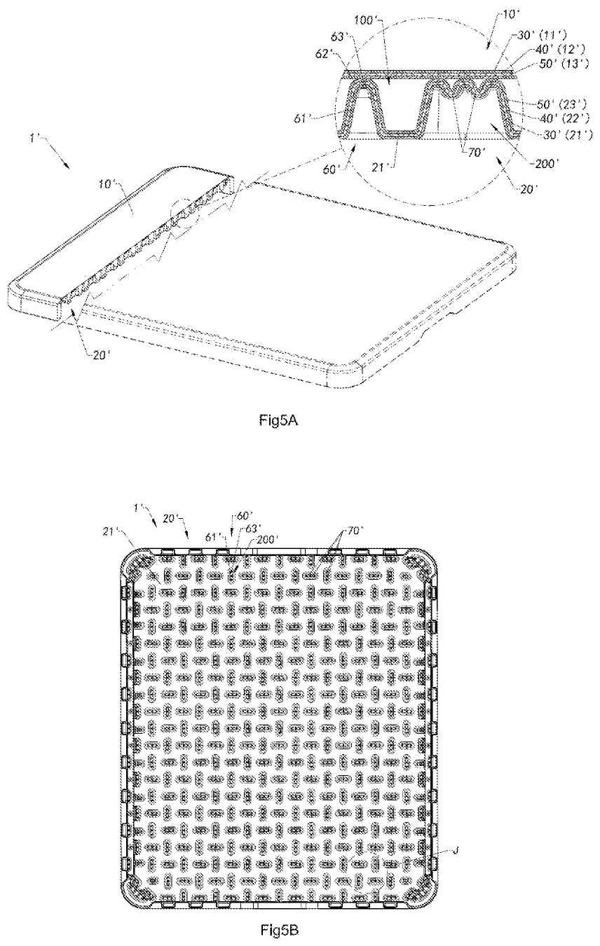

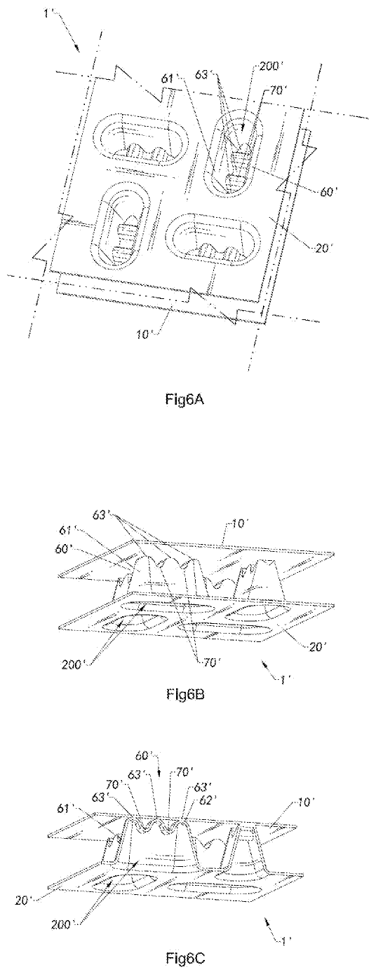

According to the present embodiment, referring to FIG. 6A, each of the support structures 60′ has a pair of the reinforcing ribs 70′ transversely across the bottom of the recessed cavity 200′, i.e., at the relatively top of the supporting structure 60′. The reinforcing ribs 70′ are U-shaped, which may be integrally extended from the support structure 60′, or may be formed through protruding and extending at least a portion of the support structure 60′ outwards.

It is worth noting that a wavy-shaped structure is an ideal reinforcing structure. Accordingly, the pair of wavy-shaped reinforcing ribs 70′ is configured to form the triple-peak wavy support structure 60′, so that the impact resistance and robustness of the second panel member 20′ can be greatly enhanced.

Referring to FIGS. 6B and 6C, the second panel member 20′ has at least a contact peak point 63′ which is positioned higher than the surrounding portions thereof and close to the first panel member 10′. In detail, the second panel member 20′ extends into the cavity 100′, i.e., toward the direction of the first panel member 10′, and extends to form the contact peak point 63′. One or more portions of he second panel member 20′ are recessed toward the first panel member 10′ until the third layer 50′ of the second panel member 20′ and the third layer 50′ of the first panel member 10′ are fused and joined with each other to form one or more the contact peak points 63′ respectively, wherein the first panel member 10′ is supported at the positions of the contact peak points 63′. At least portions of the second panel member 20′ may undulate to form the one or more contact peak points 63′. The contact peak points 63′ may be multiple in quantity and arranged in a spaced manner. Within the recessed cavity 200′, the reinforcing ribs 70′ and the contact peak points 63′ are arranged and aligned alternately in concave and convex manner respectively, as illustrated in FIG. 6A, so as to form the support structure 60′.

In other words, the contact peak points 63′ are located at the support structure 60′. At least one or more portions of the support structure 60′ protrude and extend outwardly to form the one or more reinforcing ribs 70′ so as to form two or a plurality of spaced contact peak points 63′.

According to the embodiment, as shown in FIGS. 5A-6C, the three peak points of the support structure 60′ are the three contact peak points 63′. The third layer 50′ of the second panel member 20′ at each position of the support structure 60′ is just recessed to the third layer 50′ of the first panel member 10′. According to the present embodiment, the third layer 50′ portion of the second panel member 20′ just contacts and connects with the third layer 50′ portion of the first panel member 10′. In this way, the second panel member 20′ forms a hollow panel with the first panel member 30′ through bonding the first panel member 10′ with the contact peak points 63′ of the support structures 60′. In which, the triple-peak wavy support structure 60′ constructed by the wavy-shaped reinforcing rib 70′ of the second panel member 20′, based on the bonding of each contact peak point 63′ and the first panel member 10′, also provide a reinforcing support and structure of the first panel member 10′, which directly and evenly transmits the impact and force subjected on the first panel member 10′ to the second panel member 20′ for supporting, and the cavity 100′ defined between the first and second panel members 10′,20′ also provides a buffering and shock absorbing effect.

It will be appreciated that the third layer 50′ portion of the second panel member 20′ may be integrally joined and fused with the third layer 50′ portion of the first panel member 10′, such as through a blow molding process, as illustrated in FIG. 11B.

As shown in FIG. 5B, the predetermined number of support structures 60′ are preferably staggered and evenly distributed in the longitudinal and transverse directions, and are equally spaced between one another. Thus, even if the laminated board 1′ of the present invention is a hollow structure, its material cost and weight are greatly reduced, but the laminated board 1′ is made to form an impact-resistant robust structure through the longitudinal and transverse spacing arranged structure. Also, through the contact peak points 63′ of each of the support structures 60′, multiple of the evenly distributed bonding spots of the first panel member 10′ and the second panel member 20′ are fused and joined with each other, so that the first panel member 10′ and the second panel member 20′ are better integrated, such that the impact and the force acted on the first panel member 10′ can be directly and immediately transmitted to the second panel member 20′ to be dispersed and well supported. Then, the stress will be transmitted to the support device supported on the laminated board 1′, such as a leg assembly that contacts the ground. Referring to FIG. 7, a manufacturing method of the laminated board 1′ according to the above preferred embodiment of the present invention comprises.

respectively forming the layers of the laminate panel 1′, such as the first layer 30′, the second layer 40′, and the third layer 50′; and

laminating the layers in a predetermined order to form the laminated board 1′.

In particular, the third layer 50′ is formed, wherein the third layer 50′ includes the third layer of first panel member 13′ and the third layer of second panel member 23′. The third layer 50′ surroundingly forms the cavity 100′ and the third layer of second panel member 23′ is extended toward the inside of the cavity to form at least a portion of the support structure 60′.

The second layer 40′ can be attached to an exterior of the third layer 50′ and then laminated to the third layer 50′, wherein at least a portion of the second layer 40′ and at least a portion of the third layer 50′ are extended together to form at least a portion of the support structure 60′.

Thereafter, the first layer 30′ can be attached to an outer side of the second layer 40′, and then laminated to the second layer 40′, wherein at least a portion of the first layer 30′, at least a portion of the second layer 40′, and at least a portion of the third layer 50′ are extended together to form the support structure 60′.

A boundary may be formed at the connection area of the first layer 30′ and the second layer 40′. Another boundary may be formed at the connection area of the second layer 40′ and the third layer 50′.

More particularly, after the third layer 50′ formed with raw materials, such as through molding, injection molding, blow molding, and etc. to form the third layer 50′, has been cured and solidified, the second layer 40′ with certain fluidity is then spread over the surface of the third layer 50′. Here, the second layer 40′ has a better ductility to facilitate the surface bonding between the second layer 40′ and the third layer 50′. Then, the second layer 40′ may then be cured and solidified on the third layer 50′ and be pressed and laminated on the third layer 50′. Certainly, it is understood that the second layer 40′ and the third layer 50′ may also be bonded together by means of adhesive.

Similarly, after the second layer 40′ and the third layer 50′ are obtained, the first layer 30′ with certain fluidity may be spread on the surface of the second layer 40′. Here, the first layer 30′ has a better ductility to facilitate the surface bonding between the first layer 30′ and the second layer 40′. Then, the first layer 30′ may be cured and solidified on the second layer 40′ and be pressed and laminated on the second layer 40′. Certainly, it is understood that the first layer 30′ and the second layer 40′ may also be bonded by means of adhesive. It will be appreciated that even if the first layer 30′ and the second layer 40′ employ the same material, there may still be a boundary at the connection area of the first layer 30′ and the second layer 40′ because the second layer 40′ is cured and solidified prior to the first layer 30′. This boundary does not refer to color, but rather refers to forming a boundary of the first layer 30′ and the second layer 40′ between the two layers of the material at the connection area.

Further, it should be understandable that, the first layer 30′ or the second layer 40′ is not necessarily fully formed prior to lamination. For example, the material utilized to make the first layer 30′ is powdered and disposed on the surface of the second layer 40′, so that the material of the first layer 30′ is also press-molded to form the first layer 30′ with a shape during the lamination process, while the formed first layer 30′ is pressed against the surface of the second layer 40′ as well.

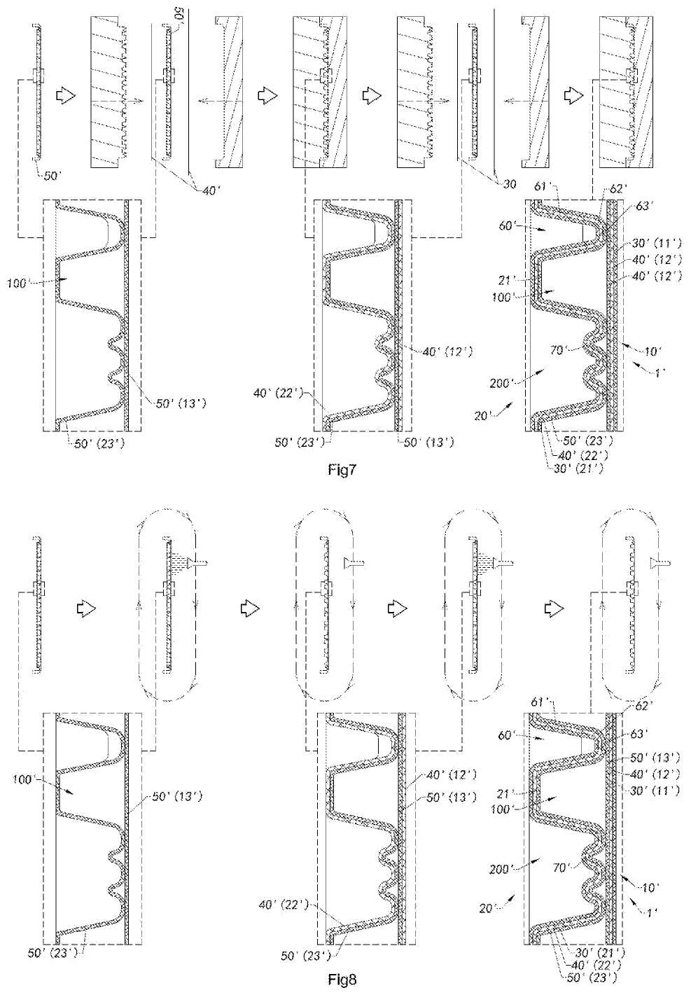

Referring to FIG. 8, another manufacturing method of the laminated board 1′ according to the above preferred embodiment of the present invention as illustrated comprises:

forming the third layer 50;

coating the surface of the third layer 50′ to form the second layer 40′ thereon; and

coating the surface of the second layer 40′ to form the first layer 30′ thereon.

In detail, the third layer 50′ cam be formed in a variety of way, such as molding, injection molding, blow molding, spraying, and etc. After the third layer 50′ is formed, the material used for forming the second layer 40′ may be applied on the surface of the third layer 50′ through spray coating or other manners. The formed third layer 50′ may also be submerged in a material used for forming the second layer 40′ so as to form the second layer 40′ on the surface of the third layer 50′. A piece of material may be coated on the surface of the third layer 50′ to form the second layer 40′.

Similarly, after the second layer 40′ is formed on the surface of the third layer 50′, the first layer 30′ may be formed on the surface of the second layer 40′. The thickness of the second layer 40′ may be controlled through controlling the counts or frequency of coating. It should be noted that different positions of the second layer 40′ may be controlled to have different thicknesses based on the needs, so as for accommodating actual requirements, such as forming a thicker second layer 40′ portion at positions that are easily being impacted.

It is understandable that the first layer 30′ may also be formed on the surface of the second layer 40′ through a press-fit manner. For example, the first layer 30′ may be directly laminated onto the surface of the second layer 40′. For convenience of operation, the first layer 30′ may not be integrally extended and may be divided into multiple pieces and then laminated to the surface of the second layer 40′ respectively.

Referring to FIG. 9, another manufacturing method of the laminated board 1′ according to the above preferred embodiment of the present invention as illustrated comprises:

forming the third layer 50;

integrally forming the second layer 40′ on the surface of the third layer 50; and

forming the first layer 30′ on the surface of the second layer 40′ to obtain the laminated board 1′.

In particular, the third layer 50′ is formed, wherein the third layer 50′ surroundingly defines the cavity 100′ formed therein, and the third layer 50′ includes the third layer of first panel member 13′ and the third layer of second panel member 23′, wherein the third layer of second panel member 23′ and the third layer of first panel member 13′ are spacingly arranged and the third layer of second panel member 23′ is extended toward the inside of the cavity 100′ so as to form at least a portion of the support structure 60′.

The third layer 50′ may be formed through blow-molding, compression molding, injection molding, or spray coating. After the third layer 50′ is prepared and finished, the third layer 50′ may be placed in a molding chamber of a first forming mold 200A′ and then the material for manufacturing the second layer 40′ is injected into the molding chamber, so that the material flows along the surface of the third layer 50′ and fills the space between the first forming mold 200A′ and the surface of the third layer 50′. Then the fluidity of the material is reduced, and the second layer 40′ is formed after curing and solidification. It will be appreciated that the cavity 100′ formed by the third layer 50′ may be relatively closed or in communication with the outside environment. If the material used for making the second layer 40′ may possibly flow into the cavity 100′ formed by the third layer 50′, the cavity 100′ may be enclosed before the forming of the second layer 40′.

It is worth noting that, since the third layer 50′ has been formed through curing and solidification, in the process of forming the second layer 40′ in the first forming mold 200A′, the forming condition and the material of the second layer 40′ are selected such that the first layer 30′ does not flow with the material of the second layer 40′. In other words, the boundary is still provided at the connection area of the first layer 30′ and the second layer 40′. Similar, after forming the second layer 40′ on the third layer 50′, the second layer 40′ and the third layer 50′ may together be placed in a molding chamber of a second molding mold 200B′, and then the material for manufacturing the first layer 30′ is injected into the molding space, so that the material flows along the surface of the second layer 40′ and fills the space between the second forming mold 200B′ and the surface of the second layer 40′. Then the fluidity of the material for manufacturing the first layer 30′ is reduced, and the first layer 30′ is formed after curing and solidification. It will be appreciated that the cavity 100′ of the third layer 50′ is closed during this process so as to prevent material from flowing into the cavity 100′.

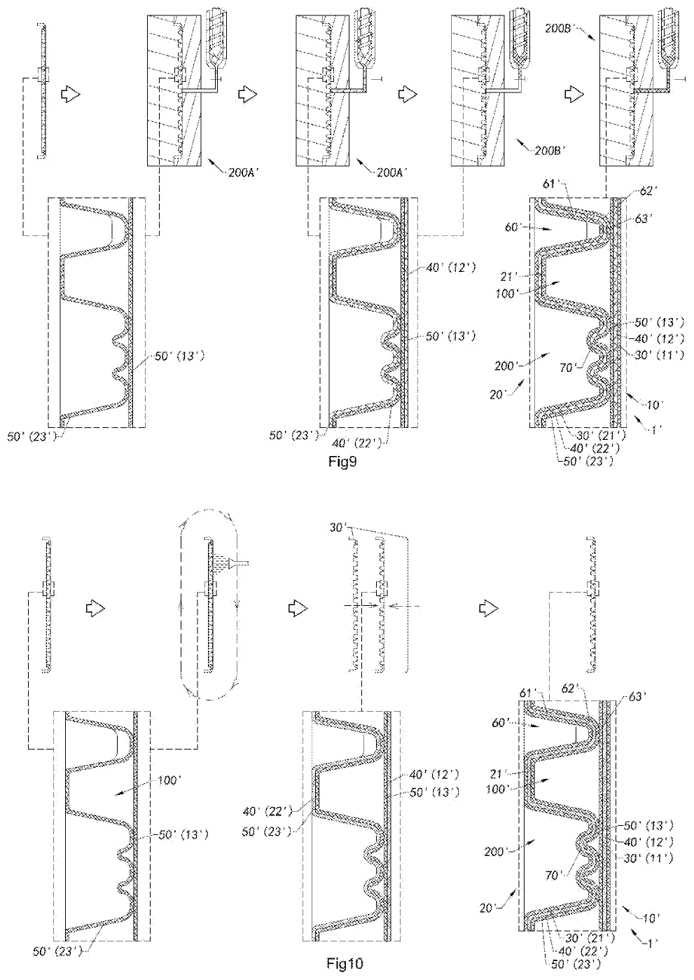

Referring to FIG. 10, another manufacturing method of the laminated board 1′ according to the above preferred embodiment of the present invention is illustrated as follows.

According to the present embodiment, the laminated board 1′ includes the first layer 30′, the second layer 40′ and the third layer 50′, wherein the second layer 40′ is implemented as a media layer for engaging and connecting the first layer 30′ and the second layer 40′.

The manufacturing method includes the steps of:

forming the third layer 50′, wherein the third layer 50′ includes the third layer of first panel member 13′ and the third layer of second panel member 23′, wherein the third layer of first panel member 13′ and the third layer of second panel member 23′ keep a space from each other and surroundingly form the cavity 100′;

arranging the second layer 40′ on the surface of the third layer 50′, wherein the second layer 40′ is capable of being bonded on the surface of the third layer 50′; and

forming the first layer 30′ on the surface of the second layer 40′, wherein the first layer 30′ is capable of being bonded on the second layer 40′, such that the first layer 30′, the second layer 40′ and the third layer 50′ are bonded with one another.

In particular, the third layer 50′ may, but not limited to, be formed through blow molding, injection molding, molding, and etc. The second layer 40′ may be sprayed or painted on the surface of the third layer 50′, or the third layer 50′ may be entirely submerged in the material of the second layer 40′, wherein the cavity 100′ is maintained closed during this process.

The first layer 30′ may be attached on the second layer 40′. For convenience of operation, the first layer 30′ may not be integral. For example, the first layer of first panel member 11′ and the first layer of second panel member 21′ are respectively manufactured, and then respectively attached to the second layer of first panel member 12′ of the second layer 40′ and the second layer 40′ of the second panel member 20′.

It is understandable that the first layer 30′, the second layer 40′ and the third layer 50′ of the laminated board 1′ are not necessarily in the order of the third layer 50′, the second layer 40′ and the first layer 30′. For example, the second layer 40′ in the middle may be prepared first. Then the material used to make the third layer 50′ is sprayed onto the inner side of the second layer 40′ to form the third layer 50′, and the material used to make the first layer 30′ is sprayed on the outer side of the second layer 40′ to form the first layer 30′.

It is understandable that the same layer does not necessarily employ the same manufacturing method. For example, the first layer 30′ portion of the first panel member 10′ may be formed on the surface of the second layer 40′ through a coating manner, and the first layer 30′ portion of the second panel member 20′ may be formed on the surface of the second layer 40′ through a press-fit manner.

It is understandable that the layers of the laminated board 1′ may be formed first and then laminated, or be laminated first and then formed.

Referring to FIG. 12 as well as FIGS. 5A and 5B, application views of the laminated board 1′ according to the above preferred embodiment of the present invention are illustrated.

The laminated board 1′ may be applied to construct a table 1000′. The table 1000′ includes a tabletop 1001′ and at least one leg assembly 1002′, wherein the tabletop 1001′ is supported on the leg assembly 1002′, wherein the number of leg of the leg assembly 1002′ may be two or more.

The desktop panel 1001′ can be prepared from the multi-layer panel 1′, and the multi-layer panel 1′ may be prepared into various shapes, such as circular, rectangular, and etc., so as to meet different needs.

At least a portion of the first panel member 10′ and at least a portion of the second panel member 20′ of the desktop panel 1001′ are disposed in a face-to-face manner and perhaps in parallel to each other.

One skilled in the art will understand that the embodiment of the present invention as shown in the drawings and described above is exemplary only and not intended to be limiting. It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1-42. (canceled)

43. A laminated board, comprising:
a first panel member;
a second panel member;
a first layer; and
a second layer, wherein said first layer is attached with said second layer to form said first panel member and said second panel member, such that a connection between said first layer and said second layer forms a boundary and at least a portion of said first panel member and at least a portion of said second panel member maintain a predetermined distance from each other to form at least one cavity therebetween, wherein said first panel member is selected from the group consisting of at least a portion of said first layer, at least a portion of said second layer, and combination thereof, wherein said second panel member is selected from at least the other portion of said first layer, at least the other portion of said second layer, and combination thereof, wherein one or more portions of said second panel member are recessed to form one or more contact peak points which are extended inwardly at the same time into the cavity in a direction toward said first panel member to support said first panel member.

44. The laminated board, as recited in claim 43, wherein said one or more portions of said second panel member are recessed in a direction toward said first panel member to form one or more support structures distributed in a predetermined manner, wherein each of said support structures forms a recessed cavity and each of said contact peak points is formed at a bottom of said recessed cavity of said corresponding support structure, wherein at least one of said one or more contact peak points is connected with said first panel member.

45. The laminated board, as recited in claim 44, wherein each of said support structures has at least one reinforcing rib arranged in said recessed cavity thereof and integrally extended at said support structure.

46. The laminated board, as recited in claim 45, wherein said reinforcing rib has a U-shaped wavy structure formed through protruding and extending at least portion of said support structure toward said first panel member, wherein said reinforcing rib stretches across said bottom of said recessed cavity to relatively form said contact peak point.

47. The laminated board, as recited in claim 46, wherein said first layer is attached on said second layer by a means selected from the group consisting of bonding connection and pressing connection, wherein said first layer is provided and formed on a surface of said second layer by a means selected from the group consisting of coating, compression, molding, and injection molding.

48. The laminated board, as recited in claim 44, wherein said first layer of said first panel member is partially located at outside, wherein a scratch resistance of said first layer is stronger than said second layer, wherein a support strength of a part of said second layer of said first panel member is stronger than a part of said first layer of said first panel member, wherein said second layer is completely covered and wrapped by said first layer, and an inner wall of said second layer surrounds to form said cavity.

49. The laminated board, as recited in claim 44, further comprising a third layer, wherein said third layer is positioned between said first layer and said second layer, and that said third layer is fused with said first layer and said second layer at connection areas thereof respectively, wherein said first layer, said second layer and said third layer jointly form said first panel member and said second panel member, such that said first panel member is selected from the group consisting of at least a portion of said first layer, at least a portion of said second layer, at least a portion of said third layer, and combinations thereof, and that said second panel member is selected from the group consisting of at least the other portion of said first layer, at least the other portion of said second layer, at least the other portion of said third layer, and combinations thereof.

50. The laminated board, as recited in claim 49, wherein said first layer of said first panel member is located outside, wherein a scratch resistance of said first layer is stronger than said second layer and said third layer, wherein a support strength of one of said second layer and said third layer of said first panel member is stronger than said first layer of said first panel member, wherein said second layer and said third layer are completely covered and wrapped by said first layer, and an inner wall of said third layer surrounds to form said cavity.

51. The laminated board, as recited in claim 47, further comprising a third layer, wherein said third layer is positioned between said first layer and said second layer, and that said third layer is fused with said first layer and said second layer at connection areas thereof respectively, wherein said first layer, said second layer and said third layer jointly form said first panel member and said second panel member, such that said first panel member is selected from the group consisting of at least a portion of said first layer, at least a portion of said second layer, at least a portion of said third layer, and combinations thereof, and that said second panel member is selected from the group consisting of at least the other portion of said first layer, at least the other portion of said second layer, at least the other portion of said third layer, and combinations thereof.

52. The laminated board, as recited in claim 51, wherein said first layer of said first panel member is located outside, wherein a scratch resistance of said first layer is stronger than said second layer and said third layer, wherein a support strength of one of said second layer and said third layer of said first panel member is stronger than said first layer of said first panel member, wherein said second layer and said third layer are completely covered and wrapped by said first layer, and an inner wall of said third layer surrounds to form said cavity.

53. The laminated board, as recited in claim 43, wherein said first panel member and said second panel member are connected to each other at edges thereof so as to surroundingly form a hollow structure of said laminated board.

54. The laminated board, as recited in claim 52, wherein said first panel member and said second panel member are connected to each other at edges thereof so as to surroundingly form a hollow structure of said laminated board.

55. A manufacturing method of a laminated board, comprising the steps of:
forming a second layer and a first layer attached to said second layer such that a connection between said first and second layers forms a boundary; and
forming a first panel member and a second panel member intervally to define a cavity therebetween to form a hollow structure of said laminated board, wherein said first panel member is selected from the group consisting of at least a portion of said first layer, at least a portion of said second layer, and combination thereof, wherein said second panel member is selected from the group consisting of at least the other portion of said first layer, at least the other portion of said second layer, and combination thereof.

56. The manufacturing method, as recited in claim 55, further comprising a step of:
extending at least a portion of said second panel member into said cavity to form at least one contact peak point, wherein said at least one contact peak point is recessed in a direction toward said first panel member until connecting with said first panel member.

57. The manufacturing method, as recited in claim 55, further comprising a step of:
forming a predetermined of support structure distributed in a predetermined manner by recessing a plurality portions of said second panel member at the same time toward said first panel member to form a plurality of recessed cavities respectively.

58. The manufacturing method, as recited in claim 56, wherein a plurality portions of said second panel member is recessed toward the first panel member at the same time to form a predetermined number of support structures distributed in a predetermined manner that each forming a recessed cavity.

59. The manufacturing method, as recited in claim 57, wherein a plurality portions of said second panel member is recessed toward the first panel member at the same time to form said predetermined number of support structures distributed in a predetermined manner.

60. The manufacturing method, as recited in claim 55, wherein said second layer is formed on a surface of said first layer by a means selected from the group consisting of coating, compression, molding, and injection molding.

61. The manufacturing method, as recited in claim 58, wherein said second layer is formed on a surface of said first layer by a means selected from the group consisting of coating, compression, molding, and injection molding.

62. The manufacturing method, as recited in claim 55, further comprising a step of:
providing a third layer, wherein said second layer is positioned between said first layer and said third layer and forms a boundary at each connection area with said first layer and said third layer, wherein the first panel member is selected from the group consisting of at least a portion of the first layer, at least a portion of the second layer, at least a portion of the third layer, and combinations thereof, wherein the second panel member is selected from the group consisting of at least another portion of the first layer, at least another portion of the second layer, at least another portion of the third layer, and combinations thereof.

63. The manufacturing method, as recited in claim 62, wherein a scratch resistance of said first layer is superior to that of said second layer and said third layer, an impact resistance of said second layer is better than that of said first layer and said third layer, and a supporting strength of said third layer is greater than that of said first layer and said second layer.

64. The manufacturing method, as recited in claim 59, further comprising a step of:
providing a third layer, wherein said second layer is positioned between said first layer and said third layer and forms a boundary at each connection area with said first layer and said third layer, wherein the first panel member is selected from the group consisting of at least a portion of the first layer, at least a portion of the second layer, at least a portion of the third layer, and combinations thereof, wherein the second panel member is selected from the group consisting of at least another portion of the first layer, at least another portion of the second layer, at least another portion of the third layer, and combinations thereof.

65. The manufacturing method, as recited in claim 64, wherein a scratch resistance of said first layer is superior to that of said second layer and said third layer, an impact resistance of said second layer is better than that of said first layer and said third layer, and a supporting strength of said third layer is greater than that of said first layer and said second layer.
